(19) United States
(12) Patent Application Publication
(10) Pub. No.: US 2009/0249590 A1
(43) Pub. Date: Oct. 8, 2009

(54) Clamp Device, Adapted in Particular to Be Secured on Members of Variable Section

(75) Inventor: Luca Maroso, Pianezze San Lorenzo (VI) (IT)

Correspondence Address: STRADLEY RONON STEVENS & YOUNG, LLP, 30 VALLEY STREAM PARKWAY, GREAT VALLEY CORPORATE CENTER, MALVERN, PA, 19355-1481, US

(73) Assignee: ALU S.P.A., Romano D'Ezzelino (VI) (IT)

(21) Appl. No.: 12/085,982

(22) PCT Filed: Nov. 2, 2006
(86) PCT No.: PCT/EP2006/010530

§ 371 Date: Jun. 3, 2008

(30) Foreign Application Priority Data
Dec. 5, 2005 (IT) PD2005A000357

(51) Int. Cl. A44B 21/00; F16B 2/18

(52) U.S. Cl. 24/499; 24/489; 24/517

(57) ABSTRACT

A clamp device adapted in particular to be secured on members of variable section. The device has a pair of jaws articulated with one another at their first end in order to oscillate from and to a closed position in which respective inner surfaces provided on the jaws substantially face one another. An adaptor member is mounted on at least one of the jaws and is hinged on that jaw in order to rotate between a first operating position in which it projects from the inner surface of the jaw and a second operating position in which it is housed within the jaw or in which it projects from the inner surface to a smaller extent than in the first operating position.

### RELATED APPLICATION

This application is a U.S. national phase application of International Application No. PCT/EP2006/010530 filed on Nov. 2, 2006.

### TECHNICAL FIELD

The present invention relates generally to clamp devices and, more particularly, to a clamp device adapted to be secured on members of variable section.

### TECHNOLOGICAL BACKGROUND

A particular, but not exclusive, application of the invention is in the preparation of modular display structures using tubular members having different sections along their longitudinal development.

This is typically true of the telescopic pillars or rods which are widely used in this field because their length can advantageously be adjusted.

The telescopic structure of these members nevertheless requires the use of clamp devices that can be adapted to the different sections of these members so as not to prejudice the versatility required of this type of structure.

Clamp devices of this type, whose function is to form a bearing and connection point for further components of the display structure such as shelves or connection beams, typically comprise a pair of jaws, which can be clamped about the jacket of the pillar or rod, in which adaptor members are provided and can be radially displaced by screws in order to adapt the inner section of the sleeve to the different sections of the telescopic pillar or rod. As a result of the screws, these devices are not very practicable in operation and are not aesthetically pleasing.

A clamp device is also known from European Patent Application No. 02796550, filed in the name of the applicant and granted as EP 1 451 476 B1, in which the adaptor members are associated with respective cams whose rotary pin can be radially displaced within the jaws. This solution, although efficient, nevertheless entails some constructional characteristics which increase production costs and limit the positioning possibilities of connection points with respect to external components.

### DESCRIPTION OF THE INVENTION

The problem underlying the present invention is that of providing a clamp device, adapted in particular to be secured on members of variable section, which is structurally and functionally designed to remedy the above-mentioned drawbacks of the conventional devices. To overcome these and other drawbacks, and in view of its purposes, the present invention provides a clamp device adapted in particular to be secured on members of variable section. The clamp device has a pair of jaws articulated with one another at their first end in order to oscillate from and to a closed position in which respective inner surfaces provided on the jaws substantially face one another. An adaptor member is mounted on at least one of the jaws and is hinged on that jaw in order to rotate between a first operating position in which the adaptor member projects from the inner surface of the jaw and a second operating position in which the adaptor member is housed within the jaw or in which the adaptor member projects from the inner surface to a smaller extent than in the first operating position.

It is to be understood that both the foregoing general description and the following detailed description are exemplary, but are not restrictive, of the invention.

### BRIEF DESCRIPTION OF THE DRAWINGS

The characteristic features and advantages of the invention are set out in further detail in the following detailed description of a preferred embodiment, illustrated by way of non-limiting example with reference to the accompanying drawings, in which:

FIG. 1 is a perspective view of a clamp device embodied in accordance with the present invention, in a first operating position;

FIG. 2 is a perspective view of a component of the device of FIG. 1;

FIG. 3 is a front elevation of the device of FIG. 1;

FIG. 4 is a plan view from the top of the device of FIG. 1;

FIG. 5 is a sectional view along the line V-V of FIG. 3 of the device of FIG. 1;

FIG. 6 is a plan view from the top of the device of FIG. 1, in a second operating position;

FIG. 7 is a sectional view along the line V-V of FIG. 3 of the device in the operating position of FIG. 6; and

FIGS. 8 to 10 are sectional views along the line VIII-VIII of FIG. 3 of the device of FIG. 1, showing successive stages of closure thereof.

### PREFERRED EMBODIMENT OF THE INVENTION

A clamp device according to the present invention is shown overall by the reference numeral 1 in the drawings and may be secured on members of variable section, not shown in the accompanying drawings, for instance a telescopic rod.

The device 1 comprises a pair of jaws 2 and 3 which are substantially semi-circular with their concave portions facing one another and are articulated with one another at their first ends 2a, 3a, respectively, in order to oscillate about an axis X between an open position and a closed position in which their opposing free ends 2b and 3b are respectively spaced from or closed against one another.

The shape of the jaws 2, 3 is chosen as a function of the section of the member on which the device 1 is adapted to be secured; consequently, in the preferred embodiment described here, the device 1 is advantageously secured on members of circular section.

The jaws 2, 3 have respective inner surfaces 4a and 5a which substantially face one another when the jaws 2, 3 are oscillated into the closed position, and opposing outer surfaces 4b and 5b in which connection recesses 18 are provided in order to enable the device 1 to be engaged in connection with any external accessories. The recesses 18 may be of any shape appropriate for the purpose and may, for instance, have a swallowtail section open at an upper side 2c, 3c of the jaws 2, 3 and closed on the opposite side.

In order to retain the jaws 2, 3 in the closed position, the device 1 comprises, at the free ends 2b, 3b, a clamping mechanism. The clamping mechanism includes a cam 7 articulated on a first articulation pin 8 disposed along an axis H, a tie-rod 9 extending between the pin 8 and a second pin 10 disposed along an axis H′, parallel to the axis H, and mounted to rotate at the free end 2b of the jaw 2, and a seat 11 provided at the free end 3b of the jaw 3 and adapted to house and engage the cam 7.

A projecting handle 12 also extends from the cam 7 and can be used to control the oscillation of the cam 7 about the pin 8; a seat, shown overall by the reference numeral 13, adapted to house the projecting handle 12 when the cam 7 has been oscillated into the closed position of the jaws 2, 3, is also provided on the free ends 2b, 3b of the jaws 2, 3.

Advantageously, the seats 11 and 13 are dimensioned so as to receive the cam 7 and the relative projecting handle 12 flush with the outer surfaces 4b, 5b when the cam 7 is oscillated into the above-mentioned closed position. Moreover, in order to enable manual access to the projecting handle 12 when it is oscillated into the closed position, the seat 13 is preferably open at the connection recess 18.

The tie-rod 9 comprises a threaded portion 9a screw-engaged in a corresponding threaded hole 10a provided in the second pin 10 and a head 9b connected, with the possibility of rotation, to the first pin 8. In this way, when the tie-rod 9 is screwed into the second pin 10, the distance between the two pins 8 and 10 and therefore between the cam 7 and the jaw 2 can be adjusted.

A spring 14 is also operational between the pins 8 and 10 in order to maintain a slight tension between the tie-rod 9 and these pins so as to prevent any accidental slackening of the tie-rod 9.

According to a first aspect of the present invention, an adaptor member 20, housed in a seat 21 open on the side of the inner surface 4a, 5a, is hinged on each jaw 2, 3 in a median zone thereof.

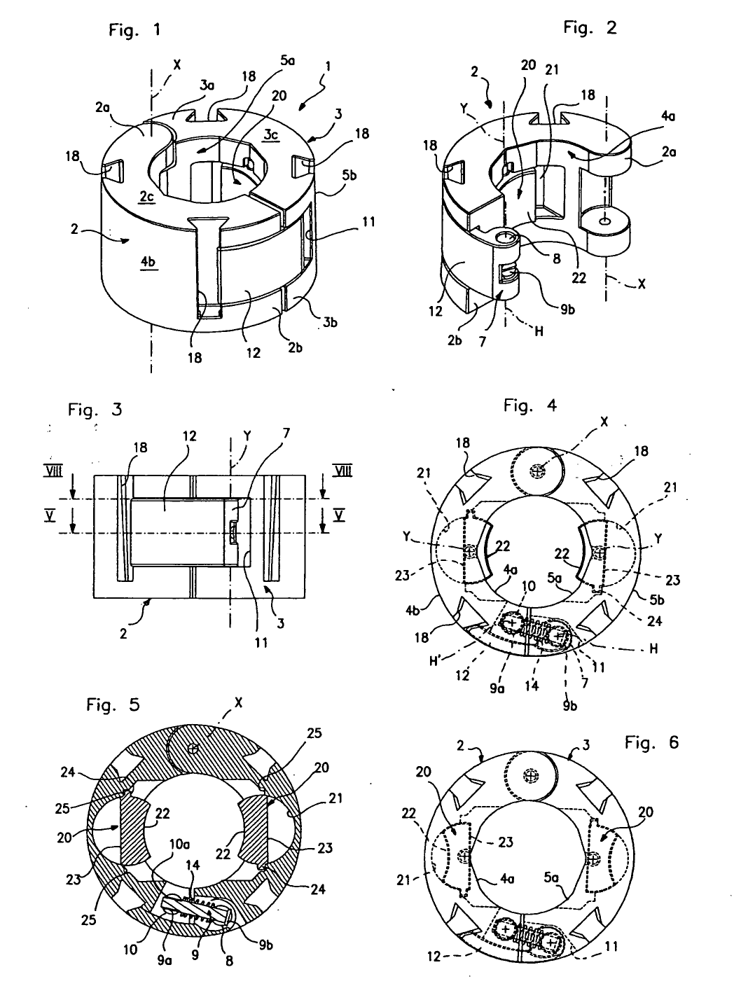

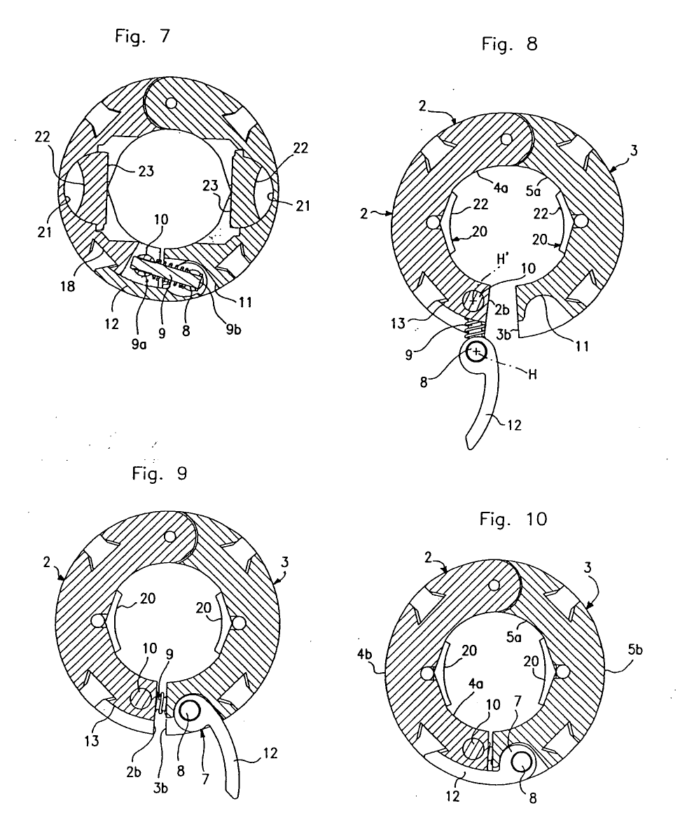

The adaptor member 20 may rotate about an axis Y in order to rotate between a first operating position in which it projects from the inner surface 4a, 5a (see FIGS. 1 to 5) and a second operating position in which the adaptor member 20 projects less than in the first operating position. Preferably, when it is rotated into the second operating position, the adaptor member 20 does not project from the inner surface 4a, 5a and is thus substantially housed within the jaw 2, 3 on which it is mounted (see FIGS. 6 and 7).

When the jaws 2 and 3 are oscillated into the closed position, the adaptor members 20 face one another in a diametrically opposing position and the inner section of the device 1 bounded by the jaws 2 and 3 is smaller if the adaptor members are rotated into the first operating position.

The adaptor member 20 comprises a first concave surface 22, with regular curvature similar to that of the inner surface 4a, 5a, and a second plane surface 23 lying on the side opposite the first surface 22 with respect to the axis of rotation Y.

When the adaptor member 20 is rotated into the first operating position, the first surface 22 faces the exterior of the jaw on which the adaptor member is mounted, while the second surface 23 faces the interior of that jaw and is opposite the base wall of the seat 21.

When, however, the adaptor member 20 is rotated into the second operating position, the relative positioning of the surfaces 22, 23 with respect to the jaw on which the adaptor member 20 is hinged is exactly the reverse.

The distance of the first surface 22 from the axis Y is greater than the distance between the second surface 23 and the axis Y so that, when passing from the first to the second operating position, the portion of the adaptor member 20 projecting from the inner surface 4a, 5a of the jaw 2, 3 decreases.

As the surfaces 22, 23 are substantially opposite with respect to the axis Y, the rotation needed to pass from the first to the second operating position and vice versa comprises an angle of approximately 180°, although configurations of the adaptor member 20 are possible in which the same effects can be obtained with different angles of rotation. It will also be appreciated that the axis of rotation Y, which is parallel to the axis X in this embodiment, can be differently oriented.

In order to enable the adaptor member 20 to be correctly locked in position when it is rotated into the first or the second operating position, a stop is provided and comprises a lip 24 extending radially from the adaptor member 20 and respective recesses 25 provided on the jaw 2, 3 in which the lip 24 is housed in abutment.

In order to increase the fastening action of the device 1 on the telescopic rod it is advantageously provided for at least the first surface 22 to be covered with a material having a high friction coefficient, for instance an elastomer material.

The device 1 is secured on the telescopic rod first by appropriately selecting the operating position of the adaptor member 20, thus determining the inner working section of the device, and then by closing the jaws 2, 3 about the rod and locking them in position by using the clamping mechanism.

The selection of the first or second operating position is carried out simply by rotating the adaptor member 20 about the axis Y until the lip 24 abuts on one or the other of the recesses 25.

With the adaptor member 20 rotated into the first operating position, the device 1 can be advantageously secured on a portion of the smaller section of the telescopic rod, while with the adaptor member 20 rotated into the second operating position, it can be secured on a portion of the larger section of this rod.

Locking of the jaws 2, 3 in the closed position requires the insertion of the cam 7 into the seat 11 of the jaw 3 and its oscillation, using the projecting handle 12, about the first pin 8 so that, as a result of its eccentric shape, the free ends 2b and 3b of the jaws 2, 3 are closed.

The degree to which the jaws 2, 3 are closed, and therefore the degree of overall tightening of the device 1, is regulated by screwing the tie-rod 9 on the second pin 10. The successive stages of closure of the jaws 2, 3 of the device 1 and their clamping are shown diagrammatically in FIGS. 8 to 10.

It will be appreciated that as the seat 21 is open only from the side towards the inner surface 4a, 5a, the adaptor members 20 are not visible from outside the device 1 once it has been closed about the telescopic rod. Moreover, in order to lock the jaws 2, 3 shut, a single cam 7 with a relative projecting handle 12 is sufficient, the cam 7 and the handle 12 being housed flush in the respective seats 11, 13 preventing any accidental impacts therewith.

The present invention thus resolves the drawbacks set out above with reference to the conventional devices. Although illustrated and described above with reference to a certain specific embodiment, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges.

1. A clamp device, adapted in particular to be secured on members of variable section, comprising:
a pair of jaws articulated with one another at their first end in order to oscillate from and to a closed position in which respective inner surfaces provided on the jaws substantially face one another; and
an adaptor member mounted on at least one of the jaws and hinged on that jaw in order to rotate between a first operating position in which the adaptor member projects from the inner surface of the jaw and a second operating position in which the adaptor member is housed within the jaw or in which the adaptor member projects from the inner surface to a smaller extent than in the first operating position.

2. The device according to claim 1, wherein the adaptor member has an axis of rotation, a first surface, and a second surface, the first and second surfaces defined as the surfaces facing the exterior of the jaw on which the adaptor member is hinged on the side of the inner surface, respectively, when the adaptor member is rotated into the first and into the second operating position, the distance between this first surface and the axis of rotation of the adaptor member being greater than the distance between the second surface and this axis of rotation.

3. The device according to claim 2, wherein the first surface of the adaptor member is concave with a regular curvature and substantially analogous with that of the inner surface.

4. The device according to claim 2, wherein the second surface of the adaptor member is substantially planar.

5. The device according to claim 1, wherein the adaptor member has a stop to lock the rotation of the adaptor member in the first and second operating positions.

6. The device according to claims 1, wherein the adaptor member is housed and engaged in rotation in a seat provided within the jaw, the seat being open only on the side of the inner surface.

7. The device according to claim 1, further comprising a clamping mechanism adapted to hold the jaws in the closed position and provided at a free end of these jaws opposite the first end.

8. The device according to claim 7, wherein the clamping mechanism includes a cam articulated on a first articulation pin, a tie-rod extending between this first articulation pin and a second pin mounted to rotate on the free end of one of the jaws, and a first seat housing the cam provided at the free end of the other of the jaws.

9. The device according to claim 8, wherein the distance between the first and second pins may be adjusted.

10. The device according to claim 9, wherein the tie-rod is screw-engaged in at least one of the first and second pins in order to adjust the relative distance between them.

11. The device according to claim 10, further comprising a spring operative between the first and second pins to maintain the tie-rod under tension with respect to the first and second pins.

12. The device according to claim 8, further comprising a second seat provided at the free end of the jaw having the second pin, wherein the cam has a projecting handle housed in the second seat, and wherein the first and second seats for housing the cam and its projecting handle are provided on the jaws in order to house the cam and the projecting handle in a substantially flush manner when disposed in the clamping position of the jaws.

13. The device according to claim 12, wherein the second seat for housing the projecting handle is open on a recess provided in one of the jaws for the connection of the device with components external thereto.

14. A clamp device, adapted in particular to be secured on members of variable section, comprising:
a pair of jaws articulated with one another at their first end in order to oscillate to and from a closed position in which respective inner surfaces provided on the jaws substantially face one another;
a clamping mechanism adapted to hold the jaws in the closed position and provided at a free end of these jaws opposite the first end; and
an adaptor member mounted on at least one of the jaws and hinged on that jaw in order to rotate between a first operating position in which the adaptor member projects from the inner surface of the jaw and a second operating position in which the adaptor member is housed within the jaw or in which the adaptor member projects from the inner surface to a smaller extent than in the first operating position, the adaptor member having a stop to lock the rotation of the adaptor member in the first and second operating positions, an axis of rotation, a first surface, and a second surface, the first and second surfaces defined as the surfaces facing the exterior of the jaw on which the adaptor member is hinged on the side of the inner surface, respectively, when the adaptor member is rotated into the first and into the second operating position, the distance between the first surface and the axis of rotation of the adaptor member being greater than the distance between the second surface and the axis of rotation,
wherein the adaptor member is housed and engaged in rotation in a seat provided within the jaw, the seat being open only on the side of the inner surface.

15. The device according to claim 14, wherein the first surface of the adaptor member is concave with a regular curvature and substantially analogous with that of the inner surface.

16. The device according to claim 14, wherein the second surface of the adaptor member is substantially planar.

17. The device according to claim 14, wherein the clamping mechanism includes a cam articulated on a first articulation pin, a tie-rod extending between this first articulation pin and a second pin mounted to rotate on the free end of one of the jaws, and a first seat housing the cam provided at the free end of the other of the jaws.

18. The device according to claim 17, further comprising a spring operative between the first and second pins to maintain the tie-rod under tension with respect to the first and second pins, and wherein the tie-rod is screw-engaged in at least one of the first and second pins in order to adjust the relative distance between them.

19. The device according to claim 17, further comprising a second seat provided at the free end of the jaw having the second pin and opened to a recess adapted to connect the device with components external to the device, wherein the cam has a projecting handle housed in the second seat and wherein the first and second seats for housing the cam and its projecting handle are provided on the jaws in order to house the cam and the projecting handle in a substantially flush manner when disposed in the clamping position of the jaws.

20. A clamp device, adapted in particular to be secured on members of variable section, comprising:
a pair of jaws articulated with one another at their first end in order to oscillate to and from a closed position in which respective inner surfaces provided on the jaws substantially face one another;
a clamping mechanism adapted to hold the jaws in the closed position and provided at a free end of these jaws opposite the first end, the clamping mechanism including a cam articulated on a first articulation pin and having a projecting handle, a tie-rod extending between this first articulation pin and a second pin mounted to rotate on the free end of one of the jaws, a first seat housing the cam provided at the free end of the other of the jaws, and a second seat provided at the free end of the jaw having the second pin and opened to a recess adapted to connect the device with components external to the device, wherein the projecting handle is housed in the second seat and wherein the first and second seats for housing the cam and its projecting handle are provided on the jaws in order to house the cam and the projecting handle in a substantially flush manner when disposed in the clamping position of the jaws;
a spring operative between the first and second pins to maintain the tie-rod under tension with respect to the first and second pins, and wherein the tie-rod is screw-engaged in at least one of the first and second pins in order to adjust the relative distance between them; and
an adaptor member mounted on at least one of the jaws and hinged on that jaw in order to rotate between a first operating position in which the adaptor member projects from the inner surface of the jaw and a second operating position in which the adaptor member is housed within the jaw or in which the adaptor member projects from the inner surface to a smaller extent than in the first operating position, the adaptor member having a stop to lock the rotation of the adaptor member in the first and second operating positions, an axis of rotation, a first surface concave with a regular curvature substantially analogous with that of the inner surface, and a substantially planar second surface, the first and second surfaces defined as the surfaces facing the exterior of the jaw on which the adaptor member is hinged on the side of the inner surface, respectively, when the adaptor member is rotated into the first and into the second operating position, the distance between the first surface and the axis of rotation of the adaptor member being greater than the distance between the second surface and the axis of rotation,
wherein the adaptor member is housed and engaged in rotation in a third seat provided within the jaw, the third seat being open only on the side of the inner surface.
